(19) United States
(12) Patent Application Publication
(10) Pub. No.: US 2005/0174079 A1
(43) Pub. Date: Aug. 11, 2005

(54) Squeeze protection system for a window lifter system in a motor vehicle as well as method of controlling a window lifter system

(75) Inventor: Gerhard Mersch, Uetze (DE)

Correspondence Address: CARLSON, GASKEY & OLDS, P.C., 400 WEST MAPLE ROAD, SUITE 350, BIRMINGHAM, MI, 48009, US

(73) Assignee: ArvinMeritor GmbH

(21) Appl. No.: 11/043,729

(22) Filed: Jan. 26, 2005

(30) Foreign Application Priority Data
Feb. 5, 2004 (DE) 10 2004 005 688.9

(51) Int. Cl. H02P 3/00; H02P 1/00

(52) U.S. Cl. 318/280; 318/469

(57) ABSTRACT

A squeeze protection system for a window lifter system in a motor vehicle includes a control that drives a drive motor to move a window pane, and a detection unit that determines whether an obstacle is in the path of the window pane. The detection unit makes an image available to the control to detect an obstacle. The detection unit is part of a vehicle surrounding detection system that can detect the presence of another vehicle, for instance, in a driver's blind spot. In addition, the control comprises a method for controlling a window lifter system in the motor vehicle.

### RELATED APPLICATIONS

This application claims priority to German Patent Application No. 10 2004 005 688.9, which was filed on Feb. 5, 2004.

### BACKGROUND OF THE INVENTION

The invention relates to a squeeze protection system for a window lifter system in a motor vehicle. The squeeze protection system includes a control that drives a drive motor to move a window pane along a path, and a detection unit that generates and communicates an image to the control. The control uses the image to detect an obstacle in the path of the window pane. Moreover, the invention relates to a method of controlling the window lifter system of the motor vehicle where the control drives the drive motor for the window pane, and the detection unit generates and evaluates an image to detect an obstacle in the path of the window pane.

In general, the invention provides active squeeze protection for a window lifter system that prevents an object, such as a hand of a vehicle occupant, from getting caught between an upper edge of a window pane and a window frame as the window pane is moved to a closed position. Active squeeze protection is distinguished from other systems in that an obstacle in the path of the window pane is detected solely based on the presence of the obstacle. In prior art systems, it is known to use an ultrasonic monitoring to detect the presence of an obstacle wherein a region through which the window pane moves is monitored. As soon as an obstacle is detected, a drive motor of the window pane is stopped or can even be driven in an opposed direction for a short time.

Another known passive system that can detect an obstacle in the path of the window pane is based on an effect of the obstacle on the window pane. Examples of such effects are a reduction of the rate of motion of the window pane, or an increase in motor current resulting from an elevated displacement resistance. These passive systems have the disadvantage that contact between the window pane and the obstacle must occur, before the squeeze protection system actually has a chance to detect the obstacle. Such necessary contact force will be additionally increased in practice because from the moment of detecting an obstacle until a standstill of the window pane is stopped, a certain amount of time will pass during which the window pane is further closed. This time span is a function of the inertia of masses of window lifter drive mechanisms. The biggest advantage of passive squeeze protection systems is their comparably low constructional effort.

With active systems, the advantage of a very early identification of an obstacle counters the disadvantage that it is relatively difficult to accommodate the components, required for the squeeze protection system, in the vehicle. Particularly, there is little space in the region of a guide for the window pane for installing a detection unit for a squeeze protection system in a practical way.

It is the object of the invention to improve an active squeeze protection system as well as to provide a method of controlling a window lifter system to the effect that control can be realized with low constructional effort.

### SUMMARY OF THE INVENTION

To this end there is provided, according to the invention, a squeeze protection system that utilizes a detection unit that is part of a vehicle surrounding detection system. The vehicle surrounding system is used to detect a presence of another vehicle lying in a blind angle of the vehicle, otherwise known as a vehicle operator's blind spot. In the process, the squeeze protection system, according to the invention, utilizes the fact that, to an increasing degree, high-quality vehicles are equipped with surrounding detection systems. Vehicle surrounding detection systems are intended to assist the vehicle operator in critical situations, or to prevent critical situations from occurring. One typical example is a generation of a warning signal to indicate that another vehicle is lying in the blind angle of a rear view mirror when the surrounding detection system determines that the vehicle operator wishes to make a lane change.

Typical surrounding detection systems use radar systems, infrared systems, or cameras as a detection unit. In most cases, the detection units are integrated in outside rear mirrors of the vehicle. The invention is based on a realization that information, which in fact is provided by these surrounding detection systems for a totally different purpose, may also be used for an active squeeze protection system. In particular, the invention is based on the realization that without any additional effort a part of an image of the vehicle surroundings, which has been taken by the detection unit, can be used for the squeeze protection system. Specifically, an outer peripheral region of this image in the area of a guide for the respective window pane can be used to identify a presence of an obstacle in a path of the window pane.

If the detection unit is a camera, a marking is preferably applied along the guide of the window pane in a detection zone, and is used by the squeeze protection system to identify the presence of an obstacle.

In order to achieve the objective mentioned above, a method is provided to identify the presence of an obstacle by using a detection unit that takes an overall image of the surroundings of the motor vehicle. A control evaluates the overall image only in a detection zone, which is relevant for identification of an obstacle in the path of the window pane. This method takes into account the fact that an image area relevant for detecting the surroundings of the motor vehicle will never overlap with an image area that is relevant for the squeeze protection system. Thus, for either image area, a separate evaluation is possible, which does not interfere with the evaluation of the other image area.

According to a preferred embodiment of the invention, provision is made that upon each opening process of the window pane, a reference image of the detection zone on the guide of the window pane is recorded for the squeeze protection system. Thus, a current reference image will be available during the subsequent closing of the window pane so that changes in the detection zone, such as contaminations of a marking that is to be visually evaluated for example, does not affect the reliability of perceiving an obstacle.

Advantageous designs of the invention will be apparent from the sub-claims. These and other features of the present invention can be best understood from the following specification and drawings, the following of which is a brief description.

### BRIEF DESCRIPTION OF THE DRAWINGS

FIG. 1 is a schematic side view of a vehicle door.

FIG. 2 is a schematic top view of the vehicle door of FIG. 1.

FIG. 3 is a schematic representation of a squeeze protection system according to the invention and of a surroundings detection system.

FIG. 4 schematically shows a mask that can be used with a detection unit of the squeeze protection system.

### DETAILED DESCRIPTION OF THE PREFERRED EMBODIMENT

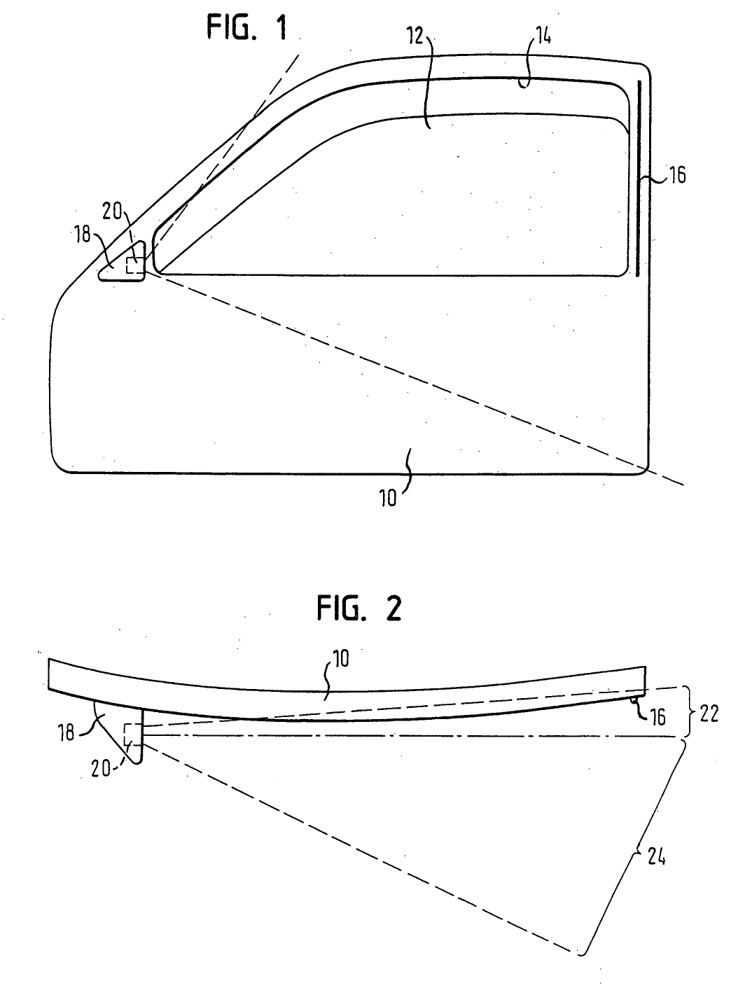

In FIGS. 1 and 2 there is shown a vehicle door 10 in which a window pane 12 is mounted for movement along a path. The window pane 12 is movably received in a guide 14. As shown in FIG. 1, there is provided along a right-hand, vertical rim of the guide 14 a marking 16 consisting of a stroke of a different color than the color of the guide 14. The marking 16 may also extend along an upper, horizontally extending part of the guide 14, as well as along a front, obliquely extending part of the guide 14. In practice the marking 16 may be integrated, such as in a window seal for example, so as to be visually inconspicuous.

Attached to the vehicle door 10 is an outside rear view mirror 18 in which a detection unit 20 is integrated. The detection unit 20 is part of a vehicle surrounding detection system with which, for example, another vehicle can be detected that lies in a “blind angle” of a vehicle, otherwise referred to as a driver's blind spot. As known, a driver has difficulty identifying the presence of another vehicle when the other vehicle is located in the blind spot.

The detection unit 20 can include a transmitter for transmitting waves as well as a sensor for receiving these waves, such as those used in a radar system or infrared system. The detection unit 20 could also include pick-up equipment system that utilizes a camera. For the purpose of the following explanation, it is assumed that the detection unit 20 includes a camera.

Dashed lines shown in FIGS. 1 and 2 indicate a zone that is covered by the detection unit 20. In this zone, the detection unit 20 takes an overall image that is subdivided in a vertical direction, in a virtual, electronic or visual way, into a detection zone 22 and an ambient zone 24. The detection zone 22 is a comparably narrow zone into which the window pane 12 falls. The detection zone 22 also includes the region of the guide 14 for the window pane 12. The ambient zone 24 is the zone facing away from the vehicle door 10, and includes the blind angle of the rear view mirror 18. The detection zone 22 and ambient zone 24 are separated from each other by a dot-dash line, as shown in FIG. 2.

As shown in FIG. 4, a mask 26 can be used to generate the detection zone 22 and the ambient zone 24 from the overall image taken by the detection unit 20. The mask 26 can be provided on the detection unit 20. The mask 26 has a detection zone opening 22′ that is comparably narrow and elongated vertically so that the area of the window pane 12 can be observed through the detection zone opening 22′. The mask 26 also includes an ambient zone opening 24′ that is comparably wide so that a region to a longitudinal side of the vehicle can be observed. It is also possible, however, to electronically subdivide the overall image into the detection zone 22 and ambient zone 24.

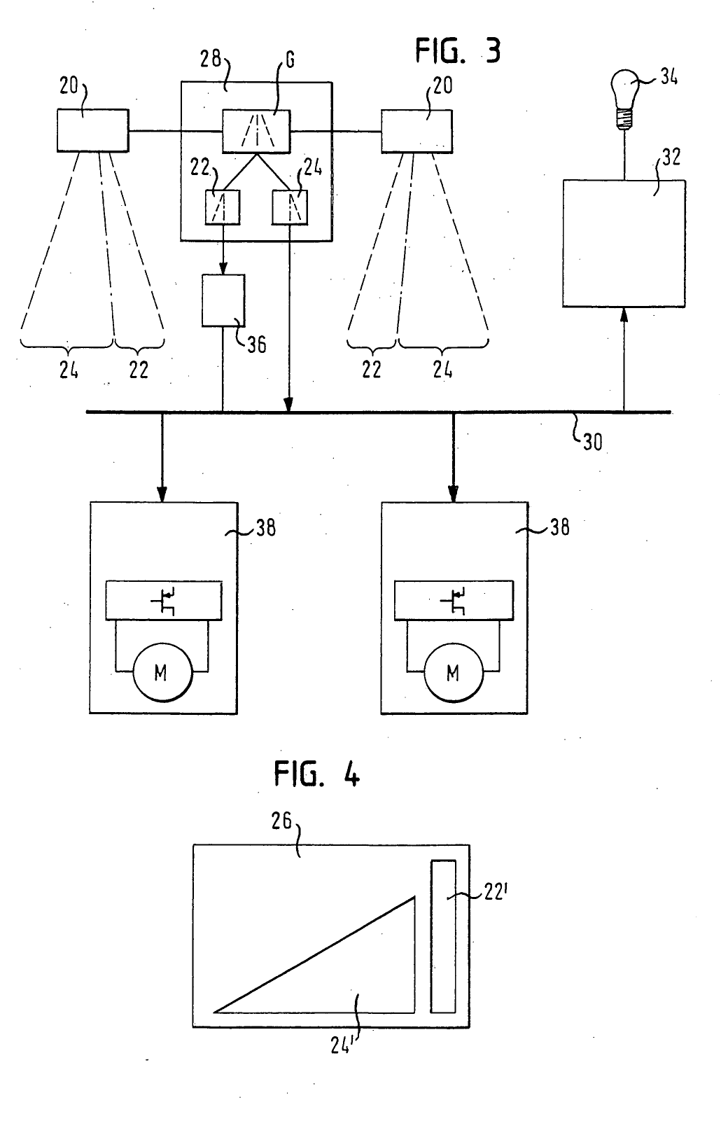

The operation of the squeeze protection system will now be explained with the aid of FIG. 3. In this example, one detection unit 20 is arranged in an outer rear view mirror 18 on each side of the vehicle. The two detection units 20 deliver (separately for each side) an overall image G that is dissected in an image detection unit 28 so as to each yield an image of the detection zone 22 and an image of the ambient zone 24.

The image of the ambient zone 24 is made available to a vehicle surrounding detection system via a bus system 30. The vehicle surrounding detection system is designed to generate an alert, such as a warning light 34, for example, if in response to a forthcoming change of lanes, a vehicle is detected in the blind angle.

The image of the detection zone 22 is made available to a control 36 of the squeeze protection system. When the control 36 sees that an obstacle lies in the detection zone 22, such as a hand of a vehicle occupant, for example, the bus system 30 and a corresponding door control device will cause a signal to be generated to halt a drive motor 38 for the window pane 12 that has the obstacle. The control 36 may also re-open the window pane 12 by a small amount to entirely eliminate the risk of a hand getting caught.

Preferably, provision is made that with each opening process of the window pane 12, the control 36 evaluates the image of the detection zone 22 and stores or records the image. In this way, a current mapping of the guide 14 for the window pane 12 is obtained, which includes the currently existing configuration of the marking 16. This will identify any contamination or obscuring of the marking 16. If the window pane 12 is being closed again, then the control 36 compares the current image of the detection zone 22, delivered by the detection unit 20, with the previously stored image. If there are deviations in the image due to a now present obstacle, such as if the marking 16 is obscured in section, movement of the window pane 12 will be immediately stopped.

The image detection unit 28 has to provide an image of the detection zone 22 only when the window pane 12 is either opened (in this case for generating a current reference image) or when the window pane 12 is being closed (in that case for generating an image to be compared with the reference image). Most of the time it is sufficient to merely evaluate the ambient zone 24. Only in the event that a window pane 12 is being opened or closed simultaneously with a forthcoming changing of lanes will the system have to provide information about the detection zone 22 as well the ambient zone 24. This, however, does not pose a problem with the transmission bandwidth of common bus systems 30.

Depending on the geometry of a particular vehicle body, the detection unit 20 may also be used to monitor a window pane between a B-column and a C-column of the vehicle. If necessary, a marking may also be provided in a region of the C-column.

Although a preferred embodiment of this invention has been disclosed, a worker of ordinary skill in this art would recognize that certain modifications would come within the scope of this invention. For that reason, the following claims should be studied to determine the true scope and content of this invention.

1. A squeeze protection system for a window lifter system in a motor vehicle comprising:
a control and a motor for driving a window pane along a path; and
a vehicle surrounding detection system including a detection unit that generates and communicates an image to the control, wherein the control utilizes the image to detect an obstacle in the path of the window pane, and wherein the vehicle surrounding detection system detects a presence of another vehicle in a vehicle operator's blind spot.

2. The squeeze protection system according to claim 1, wherein the image is a map of a detection zone defined in a vicinity adjacent the window pane.

3. The squeeze protection system according to claim 2, wherein the detection zone extends along a vertical guide of the window pane.

4. The squeeze protection system according to claim 3, wherein the detection zone has a marking along the vertical guide of the window pane that cooperates with the detection unit to identify an obstacle in the path of the window pane.

5. The squeeze protection system according to claim 4, wherein the detection unit includes a camera and the marking is comprised of a color that is different than a color of the vertical guide.

6. The squeeze protection system according to claim 1, wherein the detection unit includes a mask that divides an entire image area generated by the detection unit into an ambient zone and a detection zone.

7. The squeeze protection system according to claim 1, wherein the detection unit comprises pick-up equipment including at least one camera.

8. The squeeze protection system according to claim 1, wherein the detection unit includes a transmitter that generates reflectable waves and a sensor that receives the reflectable waves.

9. The squeeze protection system according to claim 1, wherein the detection unit is supported by an external rear view mirror of a motor vehicle.

10. The squeeze protection system according to claim 1, wherein the detection unit and the control are connected to a bus system.

11. The squeeze protection system according to claim 1 wherein the vehicle operator's blind spot is defined as an area external to the motor vehicle and which extends at an angle relative to a longitudinal side of the motor vehicle.

12. A method of controlling a window lifter system of a motor vehicle comprising the steps of:
driving a drive motor to move a window pane along a path;
generating and communicating an image to a control that controls movement of the window pane along the path wherein the image can be used to detect an obstacle in the path of the window pane; and
generating the image to include external surroundings of the motor vehicle to provide an overall image, and evaluating the overall image only in a detection zone defined as an area adjacent to the window pane to identify an obstacle in the path of the window pane.

13. The method according to claim 12, wherein the detection zone of the overall image is evaluated by the control only when the window pane is being moved to a closed position.

14. The method according to claim 12, including recording a reference image of the detection zone as the window pane is moved toward an open position.

15. The method according to claim 14, including evaluating the detection zone of the overall image as the window pane is moved to the open position, and updating the reference image each time the window pane is opened.

16. The method according to claim 12 including dividing the overall image into the detection zone and an ambient zone defined as an area external to the motor vehicle and which extends at an angle relative to a longitudinal side of the motor vehicle; and evaluating the overall image to detect a presence of another vehicle in the ambient zone prior to executing a predefined vehicle maneuver.

17. The method according to claim 16 including installing a camera in an externally mounted rearview mirror, and generating the overall image with the camera.
